(19) United States
(12) Patent Application Publication
(10) Pub. No.: US 2002/0147827 A1
(43) Pub. Date: Oct. 10, 2002

(54) Method, system and computer program product for streaming of data

(75) Inventors: Gerd Breiter, Wildberg (DE); Winfried Bruegmann, Altdorf (DE); Bernhard Schmid, Sindelfingen (DE); Hendrik Wagner, Stuttgart (DE)

Correspondence Address: Andrew J. Wojnicki, Jr., IBM Corporation - M/S P386, 2455 South Road, Poughkeepsie, NY, 12601, US

(73) Assignee: International Business Machines Corporation, Armonk, NY

(21) Appl. No.: 10/115,501

(22) Filed: Apr. 3, 2002

(30) Foreign Application Priority Data
Apr. 6, 2001 (EP) 01108695.6

(51) Int. Cl. G06F 15/16

(52) U.S. Cl. 709/231; 709/203

(57) ABSTRACT

A system, method, and computer program for streaming data from server to client, when the data is partially available on the server. A stream server is coupled to a data server and an end-user-client. The data server has a file stored in its file system which is to be rendered on the client. The file is downloaded from the data server to the stream server and cached in the media cache of the stream server. The stream server has local content data stored in memory. The streaming to the media player of the client is done from the media cache. If a data underrun occurs in the media cache, local content data is inserted into the data stream to fill in for the missing data of the file to be rendered. Thus, a streaming operation can start before the file to be streamed is completely available on the stream server.

### PRIOR FOREIGN APPLICATION

This application claims priority from European patent application serial number 01108695.6, filed Apr. 6, 2001, which is hereby incorporated herein by reference in its entirety.

### FIELD OF THE INVENTION

The present invention relates to the field of streaming of data, such as video, audio and/or business data from a stream server to a client computer, and to a corresponding computer system and computer program product.

### BACKGROUND

From U.S. Pat. No. 5,761,417 a video data streamer having a scheduler for scheduling of read requests for individual data buffers is known. The media streamer has a storage node comprising mass storage for storing a digital representation of a video presentation and a plurality of communication nodes each having at least one input port that is coupled to the storage node for receiving the digital representation.

Each of the communication nodes includes a scheduler for scheduling a read request to the storage node for a next sequential portion of a digital representation for storage within individual ones of the data buffers. Each read request for a particular individual one of the data buffers is scheduled at a predetermined time such that a requested next sequential portion of the digital representation is available to a requesting communications node prior to a time that the requested next sequential portion is required to be transmitted from the output port that is associated with the data buffer for which the read request was scheduled. The storage node further includes a scheduler for scheduling a read request to the mass storage such that a next sequential portion of a digital representation is available for outputting, prior to the at least one storage node receiving a read request for the next sequential portion from one of the communication nodes.

From U.S. Pat. No. 5,930,473 a video application server for mediating live video services is known. A video server is connected to one of the transmission media and is operative to control the broadcast and storage of multiple live or previously-stored video streams. The control can be provided via remote procedure call commands transmitted between the server and the clients.

From U.S. Pat. No. 5,586,264 a video optimized media streamer with cache management is known. A data storage system includes a mass storage unit storing a data entity, such as a digital representation of a video presentation, that is partitioned into a plurality N of temporally-ordered segments. A data buffer is bidirectionally coupled to the mass storage unit for storing up to M of the temporally-ordered segments, wherein M is less than N. The data buffer has an output for outputting stored ones of the temporally-ordered segments. The data storage system further includes a data buffer manager for scheduling transfers of individual ones of the temporally-ordered segments between the mass storage unit and the data buffer.

From U.S. Pat. No. 5,712,976 a video data streamer for simultaneously conveying data blocks to a plurality of communication nodes is known. The video representation requires a time T to present in its entirety, and is stored as a plurality of N data blocks. Each data block stores data corresponding to approximately a T/N period of the video presentation. The media streamer further includes a plurality of communication nodes each having at least one input port that is coupled to an output of the storage node for receiving a digital representation of a video presentation.

From U.S. Pat. No. 5,805,821 a similar media streamer providing a video cassette recorder-like user interface is known.

New media data extends traditional computer data formats into more natural data formats for the interaction of humans and computers by incorporating images, motion pictures, voice, audio, and video. One of the key problems with new media data is transferring the usually huge amounts of content over a network. Normally data is transferred using the store and forward paradigm, e.g. the complete content is transferred before anything is done with the data. A prominent implementation of this paradigm is the file transfer protocol (FTP), the standard way to transfer files through the World Wide Web.

For conventional data this works fine, as the amounts of data to be transferred are comparably small. Especially for audio and video clips, however, the latency time that passes between the request for rendering and a start of the rendering becomes unpractically long.

For this reason, in recent years a second paradigm called streaming has emerged. Streaming allows the rendering of the media to take place in parallel with the transfer of its content, which reduces latency times to a minimum. Streaming software always operates in pairs, a stream server application pumping the data continuously through the network and a stream player receiving the data and rendering it.

In general, prior art streaming technology is restricted to stream data which are stored on the same computer device in which the stream server application in use is residing. This, however, prevents streaming from being accomplished from any proprietary data server on which the stream server application does not run. This reveals a considerable disadvantage, as there is thus a practical constraint to store business relevant data on the streamer hardware platform instead of a higher quality computer system with an increased degree of a data security.

It is thus an object of the present invention to provide an improved method, computer system and computer program product for streaming of data.

### SUMMARY OF THE INVENTION

The objects of the invention are achieved by the features stated in the enclosed independent claims to which reference should now be made. Further advantageous arrangements and embodiments of the invention are set forth in the respective subclaims.

This invention allows the streaming process to start before the file to be streamed is fully available on the stream server.

This is in contrast to the prior art where the stream server first has to download the data file to be streamed by means of a standard FTP operation. Only when the download is complete and the file to be streamed is completely available in the stream server's file system the streaming of the data can start.

The invention allows the streaming to start when the file transfer from a data server to the stream server of the file to be streamed is still in progress. This has the advantage that the end user does not have to wait for the file transfer from the data server to the stream server to be complete until the streaming can start. This is of particular importance for both entertainment and business applications, as latency times are thereby drastically reduced.

However, a situation can not be excluded in which an underrun of the data to be streamed occurs in the buffer or cache of the stream server. This can be due to the fact that the data transmission rate between the data server and the stream server is not constant, in particular if an internet connection is used.

If the data rate for the file transfer between the data server and the stream server becomes too slow, an underrun of the data to be streamed can occur on the stream server such that the continuous stream of the data to the end user can not be maintained. The present invention is advantageous in that it allows to maintain a constant data stream to the end user by inserting of data residing on the stream server to temporarily replace the missing data from the data server and to allow the cache or buffer of the stream server to sufficiently fill up again in order to resume the streaming of the desired data to the end user.

The data on the stream server, which fills in the gap in the stream, can be of any nature, for example advertisement, news, weather report and/or local content data.

According to a further preferred embodiment of the invention the data being transferred from the data server to the stream server comprises control data to indicate allowed positions in the stream for inserting of data from the local server file system. Such control data can be inserted into the data file at logical sections of the data file content to be streamed. Such logical sections can be, for example, a certain scene of a plot, the end of a phrase or a solo portion in case of audio data.

This way the insertion of other data into the streamed data is not disturbing to the end user.

Further, the invention can be used in conjunction with the “File Future” stream server concept, as it is disclosed in EP 99 126 181.9.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is a block diagram of a computer system in accordance with the invention,

FIG. 2 is a further preferred embodiment of a computer system according to the invention including an application server in addition to the stream server,

FIG. 3 is a flow chart of an embodiment of the method of the invention, and

FIG. 4 is an example of a resulting data stream with inserted data.

### DETAILED DESCRIPTION OF A PREFERRED EMBODIMENT

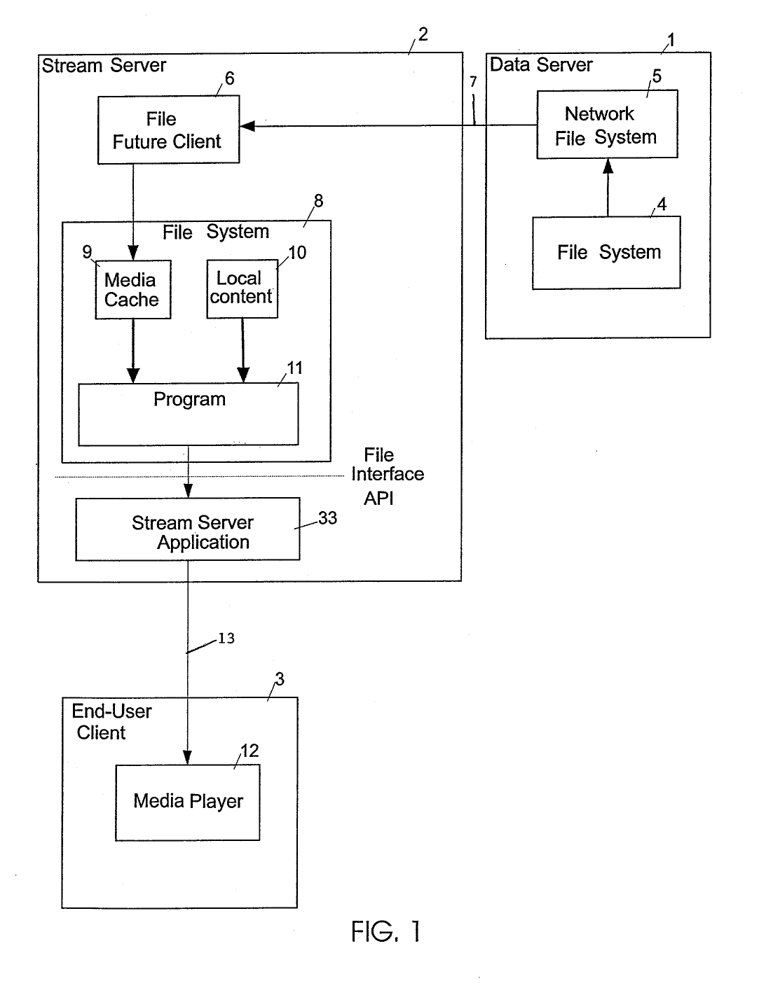

FIG. 1 shows a computer system having a data server 1, a stream server 2 and end-user-client 3. The data server 1 has a file system 4, which is coupled to a network file system 5. The file system 4 contains a number of audio, video and/or business data files for rendering on end-user-client 3. The network file system 5 can access individual files on the file system 4 for transferring to the stream server 2.

The stream server 2 has a file future client 6 which can be coupled to the network file system 5 by establishing a communication link 7. The communication link 7 can be established for example through a computer network such as the Internet.

The file future client 6 is coupled to the file system 8 of the stream server 2. The file system 8 has a cache 9 and memory 10. The cache 9 is coupled to the file future client 6 for buffering of data being received by the file future client 6 from the network file system 5 via the communication link 7. The memory 10 contains one or more data files with news, advertisement, weather report and/or local content audio and/or video files to fill in gaps in the data stream to end-user-client 3.

Further the stream server 2 has a computer program 11 for monitoring the cache 9 in order to detect an underrun situation in the cache 9. If the computer program 11 detects such an underrun it searches for an allowed position in the data received from data server 1 and buffered in cache 9 to insert data from memory 10.

The end-user-client 3 has a media player 12 for coupling to the stream server application 33 of the stream server 2. A streaming connection 13 can be established between the media player 12 and the stream server application 33. This connection can be established through the Internet.

The stream server application 33 requests block by block of the data to be streamed to Media Player 12 from the program 11 through the well-defined file interface API. The program 11 either returns the requested number of data bytes from the cache 9 or the memory 10.

In operation a file contained in the file system 4 of data server 1 is to be rendered on the media player 12 of end-user-client 3. This requires that a file transfer of the desired file is initiated between the file future client 6 and the network file system 5 via communication link 7 to transfer the file from the file system 4 to the file future client 6 from where incoming data of the file are buffered in the cache 9.

When a streaming connection 13 is established between the media player 12 and the stream server application 33 the stream server application 33 requests the first block of data to be streamed through the file interface API from the program 11. As soon as this amount of data is available in the cache 9 this data is returned from program 11 to the stream server application 33. The stream server application 33 starts to stream the data to the media player 12 on the End User Client 3 and the rendering of the desired data file starts on media player 12 while the file transfer of the desired file is still in progress between the file future client 6 and the network file system 5.

The fact that the desired file is only partially available on the stream server 2 when the streaming starts between the stream server 2 and the media player 12 is transparent to the end-user-client 3 as there is usually sufficient data of the data file to be rendered in the cache 9 for a continuous streaming operation. However, in case of an insufficient data rate of the communication link 7 an underrun can occur in the cache 9. This can be due to the fact that a transmission data rate via an Internet connection is not constant but varies over time.

Computer program 11 monitors the cache 9 in order to detect an underrun situation when the cache 9 starts getting empty, i.e. the amount of data being buffered in the cache getting below a certain predefined minimum. In such a situation the computer program 11 switches the data source of the data to be returned to the stream server application from the cache 9 to the memory 10 at an appropriate point in time, such that the data contained in the memory 10 temporarily complements the data being transferred from the network file system 5 to the file future client 6, for the purposes of streaming to the media player 12 until cache 9 is sufficiently refilled such that the streaming of the desired file can be resumed.

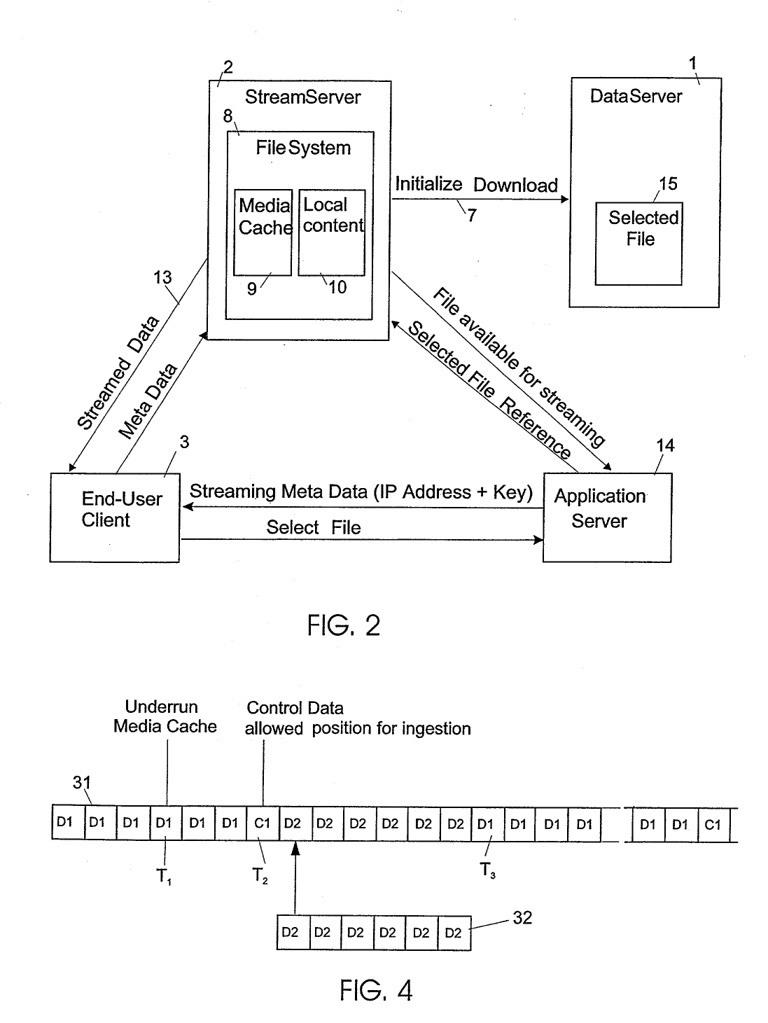

FIG. 2 shows a computer system similar to the computer system of FIG. 1 in which like elements are denoted using the same reference numerals as in FIG. 1.

The computer system of FIG. 2 has an application server 14 in addition to the components of the computer system depicted in FIG. 1. The application server 14 is coupled to the end-user-client 3 and to the stream server 2 via the Internet.

The application server 14 can be a commercial web site for offering audio, video and/or business data for streaming. End-user-client 3 can connect to the application server 14 via the Internet in order to query a database on application server 14 to identify a corresponding file of interest to end-user-client 3 and which end-user-client 3 wants to receive on its media player. End-user-client 3 selects the desired file, for example, by clicking on a corresponding symbol provided on the commercial web site portal of application server 14.

The end-user-client 3 selection of the file is transmitted from the application server 14 to the stream server 2 by means of a corresponding file reference. In response to this the stream server 2 contacts data server 1 in order to check the availability of the selected file 15 on data server 1 for downloading it.

If the selected file 15 is available for downloading, the downloading operation from data server 1 to stream server 2 is initialized. Next the stream server 2 indicates to application server 14 that the selected file 15 is available for streaming even though the download operation may not even have started.

In response to the acknowledgment received from stream server 2, application server 14 generates meta data which are required by end-user-client 3 to contact stream server 2 in order to initialize the streaming of data. Typically the meta data comprises at least an IP-address of the stream server and a key identifying the selected file. This meta data is transmitted from application server 14 to the end-user-client 3 via the Internet.

Alternatively, the meta data is generated directly by the stream server 2 and is sent as an acknowledgement to the application server 14. The application server 14 passes the meta data to the end-user client 3. In case the data is not available on stream server 2 or can not be downloaded from data server 1 the stream server 2 sends a corresponding error message to the application server 14. In this case a corresponding message is also provided to the end-user client 3.

End-user-client 3 establishes an internet connection with stream server 2 upon receipt of the meta data, by using the IP-address of the stream server 2. End-user-client 3 transmits the key to the stream server 2, in order to indicate the selected file 15 to the stream server 2 which the end-user-client 3 desires to receive, by establishing a corresponding data stream between the stream server 2 and the end-user-client 3.

In order to start streaming the data to the end user client, the stream server application requests a first block of data from the file system.

As soon as this minimum amount of data of the selected file 15 has been downloaded from the data server 1 to the media cache 9 of the stream server 2, the streaming of the data to the end-user client is started and the rendering of the selected file 15 starts on end-user-client 3.

The streaming of data can also be established at a point in time when the minimum amount of data to start the streaming is not yet available in the cache 9, by providing the stream server application with local content data out of memory 10. Once a sufficient amount of data of the selected file 15 is available in the cache 9, the provisioning of the local content data out of memory 10 is discontinued and the streaming of the data out of the cache 9 starts.

In case of a later underrun of the data in cache 9, data from memory 10 is returned to the stream server application. That has the effect that this local data is inserted transparently into the streaming connection 13 between the stream server 2 and the end-user-client 3 until the cache 9 has sufficiently filled up again.

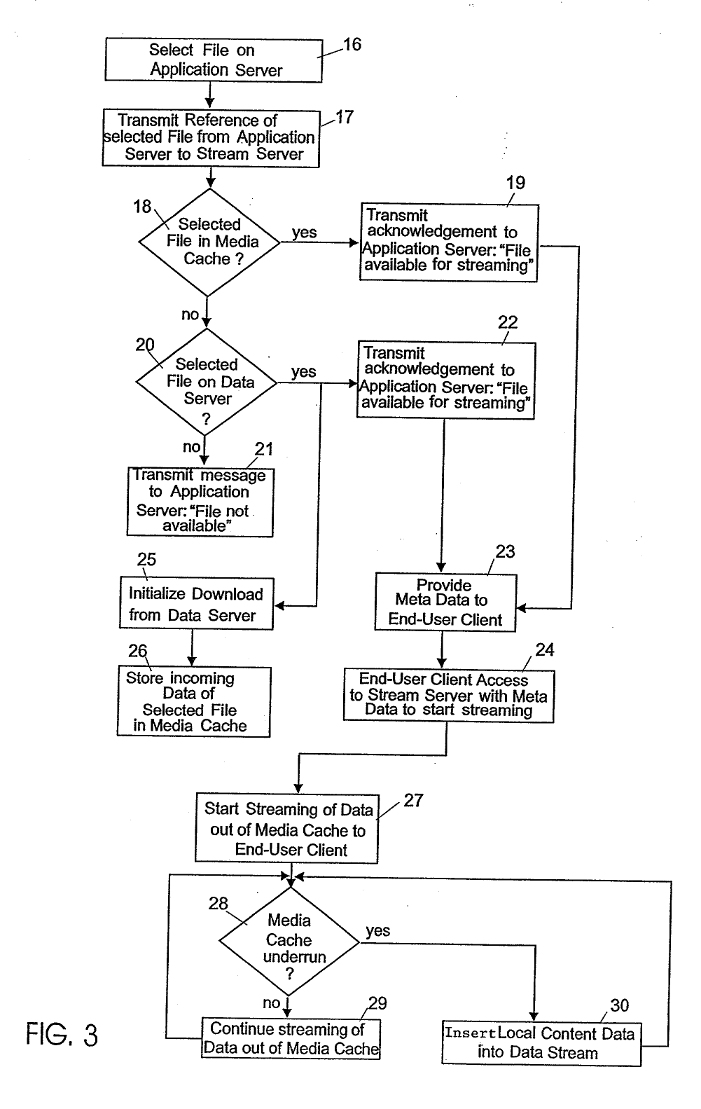

FIG. 3 shows a flow chart of an embodiment of a method according to the invention. In step 16 the end-user-client connects to the application server via the Internet in order to select a file, such as an audio, video and/or business data file, for rendering on the media player of the end-user-client computer. The application server can be a commercial portal, such as an online-shop for music and/or video, a financial portal with financial and business content. However, the application server can also be a management information system of a large corporation for distributing managerial information throughout the corporation. In this case the end-user of the client is a manager of the corporation connecting to the application server via the corporation's intranet.

After the desired file has been selected by the end-user-client on the application server, the application server transmits a reference identifying the selected file to the stream server in step 17. In step 18 the stream server decides whether the selected file is already present in the stream server's file system, such as in its media cache. If this is the case, in step 19 an acknowledgement is transmitted to the application server to acknowledge that the selected file is available for streaming to the end-user-client.

If the contrary is the case (i.e. the file is not present the stream server's file system), the stream server contacts the data server to query the data server for availability of the selected file. In step 20 the stream server decides whether the selected file is on the data server. If the selected file is not on the data server, the stream server transmits a message to the application server to indicate that the selected file is not available for streaming in step 21.

If the contrary is the case (i.e. the file is available on the data server), control goes to step 22 in order to transmit an acknowledgment to the application server to indicate that the selected file is available for streaming. Typically, this acknowledgement is sent to the application server when the selected file is not or only partially available on the stream server.

In the following step 23, the application server provides meta data to the end-user-client to enable the end-user-client to contact the stream server with a key to initialize the streaming of the selected file.

Typically the meta data is sent by the stream server to the application server. The receipt of the meta data of the application server is an implicit acknowledgement that the file is available on the stream server.

In step 24 the end-user-client connects to the stream server and provides the meta data to the stream server in order to initiate the streaming of the selected file.

Concurrently with steps 22, 23 and 24, the stream server 2 initializes the download of the selected file from the data server in step 25, and stores incoming data of the selected file from the data server in the media cache of its file system. This is done in step 26.

After the stream server has been contacted by the end-user-client in step 24, the streaming of the data of the selected file out of the media cache starts in step 27. This way the media cache of the file system of the stream server is filled with incoming data of the selected file by means of the download operation between the stream server and the data server while at the same time the media cache is read by previously downloaded data which is streamed to the end-user-client.

In case the data rate of the streaming surpasses the data rate of the concurrently occurring download operation for a certain amount of time, a media cache underrun can occur. This is decided in step 28.

If no such underrun occurs, the streaming of data out of media cache continues in step 29. If an underrun occurs, local content data is inserted into the data stream to “fill in” for the missing data of the selected file. This is done in step 30. In a preferred embodiment the local content data is inserted into the data stream only at allowed positions indicated by control data in the stream.

This is explained in more detail with reference to FIG. 4. FIG. 4 shows a data stream 31 comprising data D1 of the user selected file. At a time T₁ an underrun occurs in the media cache. In response to this underrun condition, the stream server searches for the next allowed position in the data stream 31 for inserting local content data while the streaming continues.

Such an allowed position is indicated by control data C1 which is, for example, embedded in the data stream 32. The next allowed position, as indicated by such a control data C1, is found by the stream server at a time T₂. In response to this control data C1, a substitute data stream 32 is inserted into the data stream 31 to fill in for the missing data of the selected file. The substitute data stream 32 is provided by the file system of the stream server. In particular, the substitute data stream 32 is provided by a local content file stored on the file system, such as an advertisement, news or other local content file.

It is thereby an important feature of the present invention that the provisioning of the local content is done by the file system, transparent to the stream server application 33. Usage of the present invention, therefore, does not require any changes in the stream server application, and can therefore be used with “off the shelf” stream server applications available on the market.

At a time T3 the transmission of the data of the selected file in the data stream 31 resumes. The time interval between T2 and T3 is sufficient to refill the media cache such that an uninterrupted streaming can be performed until a next underrun situation may occur.

While the invention has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

### LIST OF REFERENCE NUMERALS

Data server 1

Stream server 2

Client 3

File system 4

Network file system 5

File future client 6

Communication link 7

File system 8

Cache 9

Memory 10

Computer program 11

Media player 12

Streaming connection 13

Application server 14

Selected file 15

Step 16

Step 17

Step 18

Step 19

Step 20

Step 21

Step 22

Step 23

Step 24

Step 25

Step 26

Step 27

Step 28

Step 29

Step 30

Data stream 31

Data stream 32

Stream server application 33

What is claimed is:

1. A method for streaming first data, within a data stream, from a first server to a client, the method comprising the steps of:
commencing streaming of the first data when the first data is partially available on the first server;
inserting second data into the stream in response to an underrun of the first data on the first server, the second data being available on the first server prior to the commencing streaming of the first data.

2. The method of claim 1 further comprising the steps of:
establishing a communication link between the first server and a second server for providing the first server with a file reference of a user-selected file, and;
receiving the file reference at the first server.

3. The method of claim 1 further comprising the steps of:
establishing a communication link between the first server and a third server, the third server storing the first data;
initialising a download operation of the first data to provide a cached copy of the first data to a file system of the first server.

4. The method of claim 1, further comprising the step of caching the first data in a cache of the first server.

5. The method of claim 2, further comprising the steps of:
providing an acknowledgement from the first server to the second server to indicate that the first data is available for streaming, while the first data is less than completely available on the first server;
providing the client with meta data from the second server for access to the first server in order to trigger the commencing streaming.

6. The method of claim 1, the first data containing control data indicating one or more allowed positions in the stream for inserting the second data, the method further comprising the step of inserting the second data in the stream in at least one of the one or more allowed positions, in response to a data underrun.

7. The method of claim 1, the second data being selected from the group consisting of advertisement, news, weather report, and local content data.

8. The method of claim 1, the first data being selected from the group consisting of audio, video, and business related data.

9. The method of claim 1 further comprising inserting the second data within a file system of the first server, such that the insertion of the second data is transparent to a first server application.

10. A computer system comprising:
a first server, the first server including;
a media cache, the media cache capable of storing first data, the first data being acquired by a download operation;
a local content store, the local content store capable of storing second data;
a control program, the control program in communication with the media cache and the local content store, the control program capable of creating a data stream output including at least the first data, the control program capable of creating the data stream output when the first data is less than completely available in the media cache, the control program further capable of inserting at least a portion of the second data into the data stream output in response to a cache underrun condition, and;
a first communication link with a client for streaming the output data stream to the client.

11. The computer system of claim 10 further comprising:
a second communication link to a second server, the second communication link enabling the control program to receive a file reference of a user selected file, the second communication link further enabling the control program to send an acknowledgement to the second server, the acknowledgement indicating availability of the first data corresponding to the file reference when the first data is less than completely available in the media cache.

12. The computer system of claim 10 further comprising:
hird communication link to a third server, the third communication link enabling the first server to download the first data from the third server based on the file reference of the user selected file.

13. The computer system of claim 10, further comprising control data, the control data indicating one or more allowable positions within the first data, the control program capable of inserting at least a portion of the second data at one or more of the one or more allowable positions.

14. The computer system of claim 13, wherein the control data is embedded in the first data.

15. At least one program storage device readable by a machine tangibly embodying at least one program of instructions executable by the machine to perform a method of streaming first data, within a data stream, from a first server to a client, the method comprising:
commencing streaming of the first data when the first data is partially available on the first server;
inserting second data into the stream in response to an underrun of the first data on the first server, the second data being available on the first server prior to the commencing streaming of the first data.

16. The at least one program storage device of claim 15, wherein the method further comprises:
establishing a communication link between the first server and a second server, for providing the first server with a file reference of a user-selected file, and;
receiving the file reference at the first server.

17. The at least one program storage device of claim 16, wherein the method further comprises:
sending an acknowledgement from the first server to the second server to indicate that the first data is available for streaming when the first data is less than completely available on the first server.

18. The at least one program storage device of claim 15, wherein the method further comprises:
establishing a communication link between first server and a third server, the third server storing the first data, and
initializing a download operation of the first data to provide a cached copy of the first data to a file system of the first server.

19. The at least one program storage device of claim 15, wherein the first data includes control data, the control data indicating one or more allowable positions for inserting the second data into the data stream.

20. The at least one program storage device of claim 15, the second data being selected from the group consisting of advertisement, news, weather report, and local content data.
